(19) United States
(12) Patent Application Publication
(10) Pub. No.: US 2017/0300659 A1
(43) Pub. Date: Oct. 19, 2017

(54) APPARATUS AND METHOD FOR MONITORING PATIENT USE OF MEDICATION

(71) Applicant: LuminX Corporation, Rancho Santa Fe, CA (US)

(72) Inventors: Noam A. Ziv, Solana Beach, CA (US); Maya Ziv, Solana Beach, CA (US); Jonathan Taub, Rancho Santa Fe, CA (US); Donald Jones, Cardiff-By-The-Sea, CA (US)

(21) Appl. No.: 15/490,854

(22) Filed: Apr. 18, 2017

Related U.S. Application Data
(60) Provisional application No. 62/323,913, filed on Apr. 18, 2016.
(60) Provisional application No. 62/323,794, filed on Apr. 18, 2016.
(60) Provisional application No. 62/323,923, filed on Apr. 18, 2016.
(60) Provisional application No. 62/323,908, filed on Apr. 18, 2016.

(51) Int. Cl. G06F 19/00; G06Q 10/10

(52) U.S. Cl. CPC G06F 19/3456; G06F 19/326; G06Q 10/109

(57) ABSTRACT

Certain aspects of the present disclosure provide a cloud-based platform for monitoring patient adherence to a medication regimen. A cloud-based platform to monitor and promote patient adherence, as described herein, may help enable various useful applications.

### CROSS-REFERENCE TO RELATED APPLICATIONS

This Application claims priority to 1) U.S. Provisional Application No. 62/323,794 entitled “SMART COLLAR FOR TRACKING PATIENT ADHERENCE” filed Apr. 18, 2016, 2) U.S. Provisional Application No. 62/323,923 entitled “MECHANICAL DESIGN OF SMART COLLAR FOR TRACKING PATIENT ADHERENCE” filed Apr. 18, 2016, 3) U.S. Provisional Application No. 62/323,908 entitled “TAILORED COMMUNICATIONS TO PROMOTE PATIENT ADHERENCE” filed Apr. 18, 2016, and 4) U.S. Provisional Application No. 62/323,913 entitled “CLOUD-BASED PLATFORM FOR PATIENT ADHERENCE PROMOTION AND RELATED APPLICATION” filed Apr. 18, 2016. The disclosure of each of the foregoing applications is hereby expressly incorporated in its entirety by reference herein. Furthermore, this Application incorporates by reference the disclosure of each of the following co-pending applications in its entirety: 1) U.S. application Ser. No. 15/490,835 entitled “METHOD AND APPARATUS FOR TRACKING MOVEMENT OF AN OBJECT WITHIN A CONTAINER” filed Apr. 18, 2017, 2) U.S. application Ser. No. 15/490,836 entitled “SMART CONTAINER FOR ENHANCING INTENDED MOVEMENTS OF AN OBJECT” filed Apr. 18, 2017, and 3) U.S. application Ser. No. 15/490,814 entitled “APPARATUS AND METHOD FOR ANALYZING ADHERENCE TO A MEDICATION REGIMEN” filed Apr. 18, 2017.

### BACKGROUND

### Field of the Disclosure

Certain aspects of the present disclosure generally relate to healthcare and, more particularly, to mechanisms for monitoring and/or promoting patient adherence to a prescribed regimen.

### Description of Related Art

Patient adherence generally refers to how well a patient takes medication, according to a regimen prescribed by a healthcare provider. In other words, patients are considered adherent when they take the prescribed medications at doses and times according to the regimen. Patient adherence is obvious a key component of treatment success. Non-adherence can lead to poor patient outcome and increased health costs.

As patient non-adherence has been recognized a contributing factor in rising health care costs, recent efforts have been made to monitor patient adherence. Such monitoring has a potential to help reduce cost and improve patient health by improving the effectiveness of care delivered. Such monitoring may help distinguish between poor treatment response and patient non-adherence. As such, monitoring adherence may help guide providers in prescribing decisions, identifying causes of non-adherence, and take measures to promote adherence.

Conventional mechanisms for monitoring adherence include clinical assessments, where patient usage is observed and recorded, and patient self-reporting. Each of these mechanisms has their own drawbacks. For example, clinical assessments of patient adherence are typically inconvenient, costly, and time-consuming, while patient self-reporting is notoriously unreliable.

For these reasons, improved mechanisms for monitoring and/or promoting patient adherence are desirable.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Aspects of the present disclosure provide an apparatus for tracking a count of objects in a container. The apparatus generally includes a housing mountable at an opening of the container, at least one detector proximate the opening and responsive to removal of objects from (or insertion of objects into) the container, a processor configured to process a first signal generated by the detector to update a monitored count of objects in the container, and an interface for transmitting a wireless signal indicative of at least one of the monitored count or a change in the monitored count.

Aspects of the present disclosure provide an apparatus for monitoring patient adherence to a medication regimen. The apparatus generally includes a container for holding objects, a housing mountable at an opening of the container, at least one detector proximate the opening and responsive to removal of objects from the container, a processor configured to process a first signal generated by the detector to update a monitored count of objects in the container, and an interface for transmitting a wireless signal indicative of at least one of the monitored count or a change in the monitored count.

Aspects of the present disclosure provide a cloud-based platform to monitor and promote patient adherence. Such a cloud-based platform may help enable various useful applications.

Certain aspects of the present disclosure also provide various methods, apparatus, and computer-program products for performing operations performed by the apparatus described above.

An aspect of the present disclosure provides an apparatus for providing medication monitoring for a patient. The apparatus comprises a receiver circuit configured to receive a wired or wireless signal indicating information regarding dispensing of a medication from a container via an electronic communication. The apparatus also comprises a memory circuit configured to store and provide access to at least one of the information regarding dispensing of the medication, information regarding a medication regimen of the patient, information regarding the medication, and an indication of adherence or non-adherence of the patient to the medication regimen. The apparatus further comprises a processor circuit configured to generate one or more alerts to the patient regarding at least one of: the medication, the medication regimen, and an adherence or non-adherence of the patient to the medication regimen. The apparatus further also comprises a transmit circuit configured to transmit the one or more alerts to a receiver device accessible by at least one of the patient, the healthcare provider, or the person associated with the patient.

Another aspect of the present disclosure provides a method of providing medication monitoring for a patient. The method comprises receiving a wired or wireless signal indicating information regarding dispensing of a medication from a container. The method also comprises storing and providing access to at least one of the information regarding dispensing of the medication, information regarding a medication regimen of the patient, information regarding the medication, and an indication of adherence or non-adherence of the patient to the medication regimen. The method further comprises generating one or more alerts to the patient regarding at least one of: the medication, the medication regimen, and an adherence or non-adherence of the patient to the medication regimen. The method further also comprises transmitting the one or more alerts to a receiver device accessible by at least one of the patient, a healthcare provider, or a person associated with the patient.

An aspect of the present disclosure provides an apparatus for providing medication monitoring for a patient. The apparatus comprises means for receiving a wired or wireless signal indicating information regarding dispensing of a medication from a container. The apparatus also comprises means for storing and providing access to at least one of the information regarding dispensing of the medication, information regarding a medication regimen of the patient, information regarding the medication, and an indication of adherence or non-adherence of the patient to the medication regimen. The apparatus further comprises means for generating one or more alerts to the patient regarding at least one of: the medication, the medication regimen, and an adherence or non-adherence of the patient to the medication regimen. The apparatus also further comprises means for transmitting the one or more alerts to a receiver device accessible by at least one of the patient, a healthcare provider, or a person associated with the patient.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a diagram of an example adherence monitoring platform, in accordance with certain aspects of the present disclosure.

FIG. 2 illustrates a diagram of an example adherence monitoring platform, in accordance with certain aspects of the present disclosure.

FIG. 3 illustrates example operations for monitoring object removal (and/or insertion) from a container, in accordance with certain aspects of the present disclosure.

FIG. 4 illustrates example operations for updating adherence information, in accordance with certain aspects of the present disclosure.

FIG. 5A illustrates an example sequence of operations for updating adherence information via a container with a smart collar, in accordance with certain aspects of the present disclosure.

FIG. 5B illustrates an example sequence of operations for communicating an alert based on adherence information via a container with a smart collar, in accordance with certain aspects of the present disclosure.

FIG. 6 illustrates an example container with a smart collar for monitoring removal and/or insertion of items from the container, in accordance with certain aspects of the present disclosure.

FIG. 7A illustrates an example smart collar with one or more sensors to detect travel of an object (such as a pill) from an opening of the smart collar, in accordance with certain aspects of the present disclosure.

FIG. 7B illustrates an example arrangement of one or more sensors, in accordance with certain aspects of the present disclosure.

FIG. 7C illustrates another example arrangement of one or more sensors, in accordance with certain aspects of the present disclosure.

FIG. 8 illustrates an example schematic diagram of a smart collar, in accordance with aspects of the present disclosure.

FIG. 9 illustrates example operations for tailored communications with patient, in accordance with certain aspects of the present disclosure.

FIG. 10 illustrates an example sequence of operations for tailored communications with a patient, in accordance with certain aspects of the present disclosure.

FIG. 11 illustrates a table summarizing various applications that may be enabled by a cloud-based platform, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure generally relate to a platform for monitoring patient adherence to a medication regimen. Aspects of the present disclosure also relate to various components that may help enable such a platform, such as a smart collar that can detect and communicate information related to adherence. As described herein, a smart collar that seamlessly integrates with a medicine container may result in a cost effective mechanism to communicate accurate (e.g., on the order of per-pill accuracy) information regarding patient adherence.

Aspects of the present disclosure also provide for tailored communications with a patient. For example, a mode of communicating with the patient to encourage adherence to a medication regimen may be adjusted based on feedback or inferences regarding why the patient is not adhering to the regimen.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Platform for Monitoring Patient Adherence

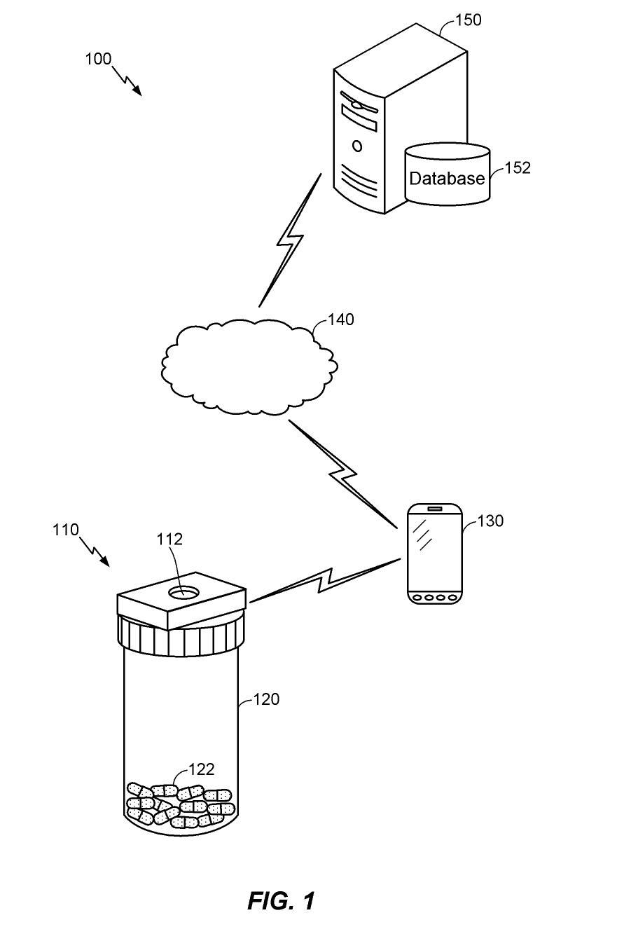

FIG. 1 illustrates a system 100 in which aspects of the disclosure may be performed. The system 100 may be considered a cloud-based platform for monitoring patient adherence. The system 100 includes a server 150 with a database 152, a network 140, a smartphone 130, and a medication bottle or container 120. The container 120 includes a plurality of objects 122 (e.g., pills or medication). The container 120 may be a cylinder that is enclosed at one end and open at the other end. The open end of the container 120 may be referred to herein as the “mouth” of the container 120. The container 120 may include a smart collar 110 coupled to the mouth of the container 120. The smart collar 110 may include an opening 112 that passes through the entire smart collar 110 and provides for the dispensing of the objects 122 from or inserting of the objects 122 into the container 120.

In the illustrated example, the smart collar 110 may be fitted to the container 120 and configured to monitor the removal and/or insertion of the objects 122 from the container 120. As will be described in greater detail below, the smart collar 110 may include one or more components (such as photo-interrupter or processor) capable of detecting the removal and/or insertion of the objects 122 (or any detectable amount of container contents) through the opening 112.

As an illustrative, but not limiting example, the container 120 may be a pill bottle and the objects 122 may be pills. Thus, the smart collar 110 may maintain and update a pill count as pills are taken from or added to the container 120. In such cases, the smart collar 110 may be adapted to couple with standard size pill bottles (e.g., replacing standard lids or being fitted into the standard size pill bottles so existing lids may continue to be used) or with custom size pill bottles. The smart collar 110 may be a separate component or, in some cases, may be an integral part of the container 120. While the pill bottle is described to facilitate understanding, the techniques and mechanisms described herein may be used to monitor any type of detectable content (e.g., whether solid, liquid, or gas) removed from or added to the container 120.

The smart collar 110 may have one or more interfaces allowing communication with the network 140, such as a cloud computing network. As used herein, the term cloud computing generally refers to any type of network-based (e.g., Internet-based) computing that provides shared processing resources and data to devices on demand. As such, cloud computing may be considered a model for enabling on-demand access to a shared pool of configurable computing resources, which can be rapidly provisioned and released with minimal management effort.

The network may be used to exchange messages among several interacting spatially-separated devices. In some embodiments, the network may be classified according to geographic scope, which could be, for example, a metropolitan area, a local area, or a personal area. Such a network may be designated respectively as a wide area network (WAN), metropolitan area network (MAN), local area network (LAN), wireless local area network (WLAN), or personal area network (PAN). Wireless communication networks may be widely deployed to provide various types of communication content such as voice and data. Typical wireless communication networks may be capable of supporting communication with multiple users by sharing available network resources (e.g., bandwidth, transmit power). Examples of such networks may include code division multiple access (CDMA) networks, time division multiple access (TDMA) networks, frequency division multiple access (FDMA) networks, orthogonal frequency division multiple access (OFDMA) networks, and the like. Additionally, the networks can conform to specifications such as third generation partnership project (3GPP), 3GPP2, 3GPP long-term evolution (LTE), LTE Advanced (LTE-A), LTE Unlicensed (LTE-U), LTE Direct (LTE-D), License-Assisted Access (LAA), MuLTEfire, etc. These networks may be accessed by various types of user equipment (stations) adapted to facilitate wireless communications, where multiple stations share the available network resources (e.g., time, frequency, and power).

Communications between the network 140 and the collar 110 may be bi-directional and may be used to exchange event information, configuration, alerts, or other information. In some embodiments, communications between the network 140 and the smart collar 110 may be unidirectional (e.g., from the smart collar 110 to the network 140) and communications to the patient using the smart collar 110 may occur via the smartphone 130.

In general, smart collar 110 to network 140 communications may be opportunistic and may occur via one or more paths, over multiple types of links (possibly wireless), either directly or indirectly (via gateway). In some cases, a device other than the smartphone 130 may serve as a gateway to the network 140. For example, gateway functionality may be provided as part of another connected device (TV, thermostat, Echo, or the like, not shown in this figure).

In the present example, the network 140 may allow information from the smart collar 110 to be communicated (e.g., via packets or other type messages) to the server 150 that monitors patient adherence. Information related to a pill count may include, for example, an absolute or relative pill count, change in pill count, number or rate of pills taken over a given time period, times at which pills were refilled, etc. Such information related to one or more patients may be stored in the database 152 and such information may be analyzed as part of an overall scheme to monitor and attempt to encourage patient adherence to a medication regimen. In some embodiments, the medication regimen may include a schedule or frequency at which medication (e.g., the medication included in the container 120) is to be dispensed from the container 120 and consumed by the patient. In some embodiments, the medication regimen may include information regarding a plurality or all medications that the patient consumes, both prescribed and over-the-counter medications. In some embodiments, the medication regimen may include more than just medications but also other activities or procedures that may affect the patient's health, such as physical activity or weekly dialysis, etc.

The smart collar 110 may include any combination of interfaces to communicate with network 140 directly or indirectly. In the example illustrated in FIG. 1, the smart collar 110 may indirectly communicate with the network 140 via smartphone 130 (such as a mobile device), for example, via Bluetooth, Bluetooth low energy (LE), ZigBee, Wi-Fi, NFC (or other type of wireless local area network-WLAN). The smartphone may run an application (app) that is configured to communicate with the smart collar 110, gather data and, in some cases, present adherence data to a patient and/or notifications to a patient.

As will be described in greater detail below, in some cases, such an app may also be used to view information regarding a medicine as an alternative (or in addition) to conventional printed (and sometimes difficult to read) documentation.

In some cases, the smart collar 110 may include local storage to store information such as a medication regimen, the information for a particular medication, or other information.

Once provisioned with the medication regimen information, local storage of the smart collar 110 may provide for autonomous collar operation when the network is not accessible.

In some cases, the cloud computing network 140 may update information stored on the smart collar 110 such as medication regimen, the information for a particular medication (“booklet”), or other information. The smart collar 110 described herein may accommodate such updates at home (e.g. with no need to visit a pharmacy), or at other locations (pharmacy or medical provider), or at remote locations (e.g., while traveling, while at work, etc.).

In some cases, in order to protect sensitive patient information, the smart collar 110 may encrypt events, the medication regimen, and other provisioned or collected information. Such encrypted information may be saved locally and may be deleted upon server command or remote request by one of the patient or a healthcare provider.

In some cases, devices other than the collar (e.g., apps on phones or TVs, laptops, security systems, thermostats, etc.) may be used to present informational content to the patient or person associated with the patient. Depending on the deployment, such information may or may not follow the same communication path as the server to collar communications. In some cases, once activated and provisioned, a collar may operate autonomously (e.g., without any server communication) and, in such cases, the collar may generate local informational content (e.g., using whatever capabilities it has) as well as collect and save event information (e.g., any suitable form of local memory). In some cases, such local alerts/storage may be performed only until a connection is obtained. In other cases, such local alerts/storage may be supplemental (e.g., performed regardless of connectivity).

As noted herein, certain medication (“booklet”) information may be stored locally to a collar. In such cases, such information may be accessed by connecting a viewer to the collar (app, TV, computer, refrigerator, or the likes).

In some cases, a collar may be provisioned to help users locate (“find”) it. In some cases, a collar may include other “user facing” features such as an “OK reminder” (e.g., indicating to a user they are in compliance and taking pills on time).

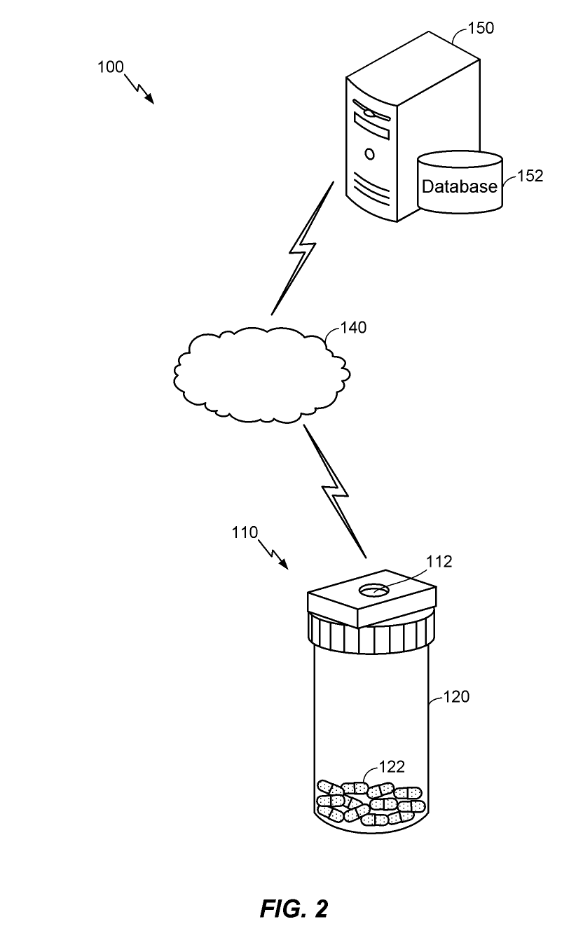

As illustrated in FIG. 2, in some cases, a smart collar may communicate via different types of connections, such as directly with the network 140 (e.g., without needing the smartphone 130 or any other separate device for connectivity to the network 140). In some cases, a smart collar 110 may be capable of communicating both directly or indirectly with the network 140. In such cases, whether the smart collar 110 communicates directly or indirectly may be based on one or more conditions (e.g., channel conditions, a power savings mode, a state of a battery of the smart collar 110, and/or availability of a direct connection). For example, when the smart collar 110 is in a power savings mode or the battery power is below a threshold level, the smart collar 110 may communicate indirectly with the network 140, which may utilize less power than communicating directly with the network 140.

For such direct or indirect connectivity with the network 140, the smart collar 110 may include one or more radios (e.g., transceivers 808) that support one or more radio access technologies (RATs) or other type of wireless technologies (e.g., audio or light communications which may not need an antenna). In some cases, a particular RAT or RATs supported may be determined based on cost considerations. Examples of such RATs include, but are not limited to Bluetooth, Bluetooth low energy (LE), ZigBee, Wi-Fi (or other type of wireless local area network-WLAN), or Cellular (or other type of wireless wide area network-WAN). Thus, a wide variety of options exist for providing a gateway to connect the smart collar 110 to the network 140 directly or indirectly. In some cases, the smart collar may communicate using (piggyback on) one or more existing gateways, such as Amazon Echo, smart televisions with radios and networking, home automation and/or security systems, or using a dedicated Gateway (such as 2net).

In general, any suitable type of gateway or direct communications (or other type connectivity) may be supported to allow the smart collar 110 to communicate information via the network 140. As will be described in greater detail below, in some cases, two-way communication may be used between the smart collar 110 and the cloud. For example, data may flow from the smart collar 110 to the cloud (for example, in an event driven manner or in a request/response manner) and data may also flow from the cloud to the smart collar 110 (e.g., configuration information, notifications, or other type information).

In some embodiments, the smart collar 110 may be selectively configured via the cloud. In some embodiments, the smart collar 110 may request the patient to approve any configuration. In some embodiments, the smart collar 110 may also provide the patient options to select what kinds of alerts to receive or what kinds of information to provide over the cloud to devices of the network 140.

As noted above, in some cases, the smart collar 110 may provide functionality even during times when there is no connection to the cloud (times of Non- Connectivity). In such cases, the smart collar may be configured to collect and store data until a connection is gained. In some cases, once activated and configured, data collected by the collar may be encrypted and stored locally on the collar. Such data may be uploaded to the cloud opportunistically (e.g., when connectivity becomes available). In some cases, data may be erased from collar once cloud confirms correct receipt of that data (e.g., via an acknowledgement message).

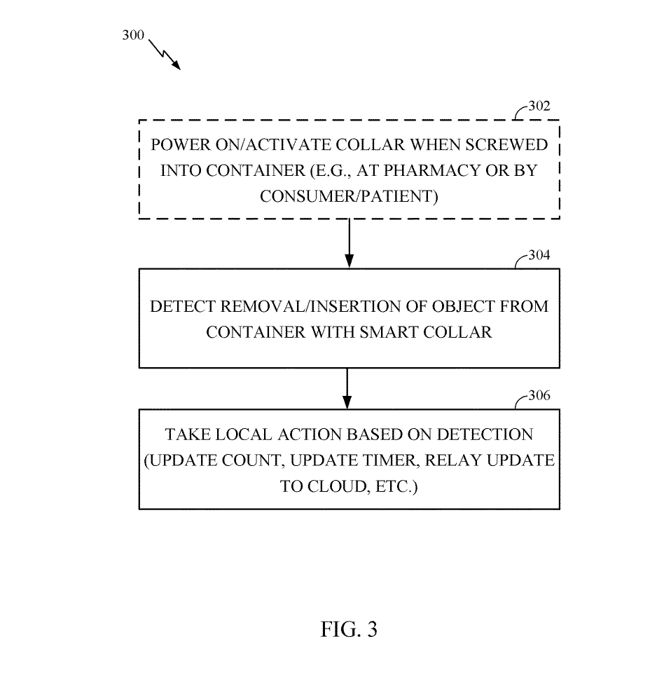

FIG. 3 illustrates example operations 300 for monitoring object removal (and/or insertion) from a container, in accordance with certain aspects of the present disclosure. The operations 300 may be performed, for example, via one or more components (e.g., sensors and processors) of the smart collar 110.

As illustrated at 302, in some cases, the smart collar may be powered on or activated when installed. For example, the smart collar may be powered on or activated when screwed into a pill bottle at a pharmacy or by the patient. In some cases, a smart collar may be activated during assembly/manufacture of a pre-packaged container (e.g., containing a fixed dosage of pills or other type medicine). In some cases, a bottle may be “provisioned” with information related to a particular patient medication regimen, type of medicine (e.g., pill type/size) as well as various other type of configuration information. At 304, the smart collar detects removal of an object from (and/or addition of an object to) the container. At 306, the smart collar takes action based on the detection.

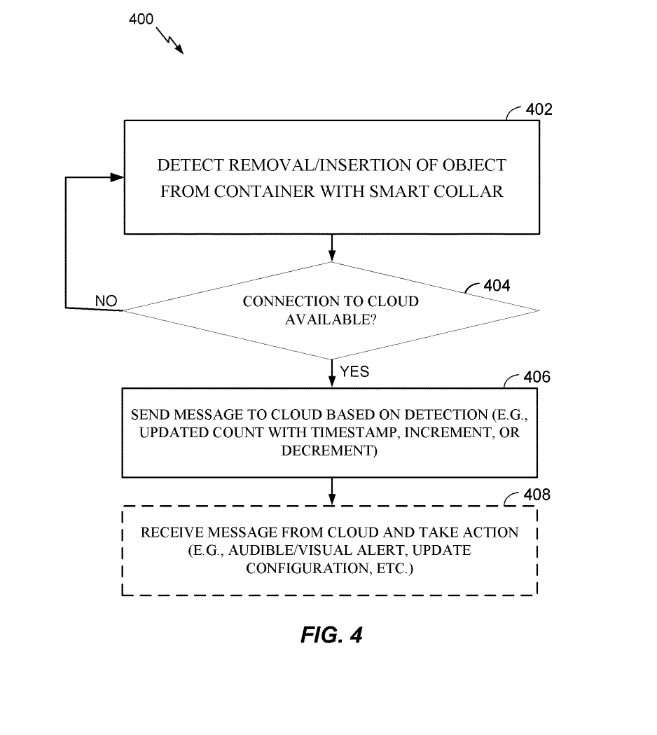

As described above and illustrated in operations 400 of FIG. 4, in some cases, the action taken may depend on current connectivity to the cloud. At 402, the smart collar detects removal of an object from (or addition of an object to) a container. If a connection to the cloud is not available, as determined at 404, for example, the smart collar may update and maintain a pill count locally and continue to detect a change in pill count.

Once a connection is available, at 406, the smart collar may send a message to the cloud. For example, the message may indicate an updated count, a change (increment or decrement) in pill count and may include a timestamp or an indication of a time period over which the count changed. As noted above, the message may be sent directly to the cloud or indirectly (e.g., via a smartphone).

Optionally, at 408, the smart collar may receive a message from the cloud and take action accordingly. The message, for example, may be generated in response to the adherence information sent (at 406). As an example, the message may be a reminder sent via the smartphone app described above (or sent directly to the smart collar). In some cases, the collar may have a mechanism to provide audible alerts (e.g., a speaker or buzzer) and/or visual alerts (e.g., via an LED or small display). As another example, the message may simply acknowledge the cloud received the message sent at 406 (e.g., and the smart collar may delete locally stored data in response to the acknowledgement).

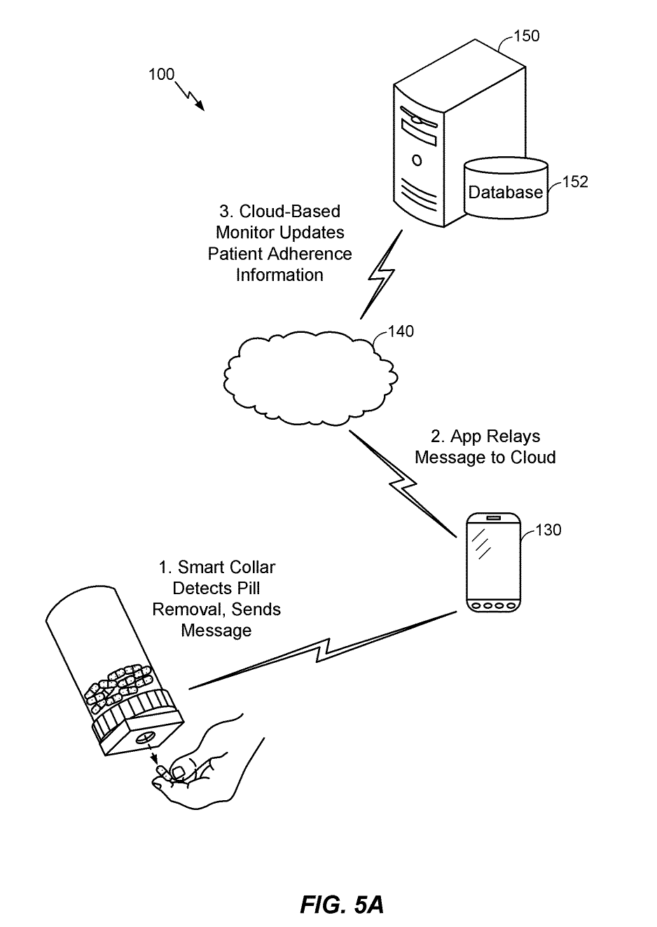

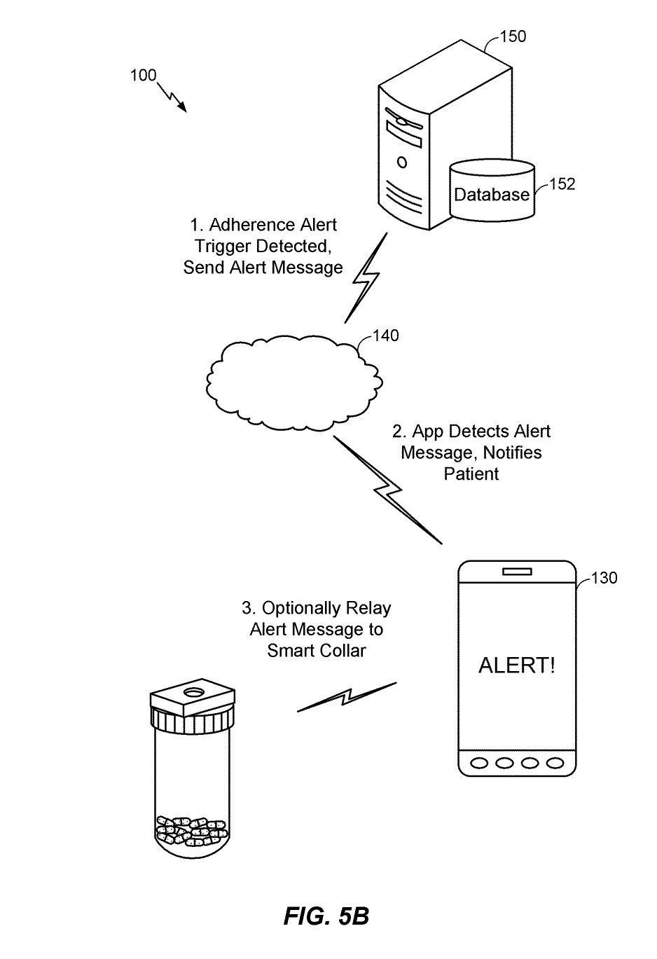

FIG. 5A illustrates an example sequence of operations for updating adherence information via a container with a smart collar, in accordance with certain aspects of the present disclosure. As illustrated, the smart collar may first detect pill removal and send a message to the cloud, relayed through a smartphone in this example. The cloud-based monitoring (e.g., at server 150) may then update patient adherence information accordingly (e.g., in database 152).

As illustrated in FIG. 5B, in some cases, the cloud-based monitoring may generate an alert message (or other notification) in response to some trigger event. For example, a simple reminder may be sent periodically if the server does not receive an update indicating a patient has taken medicine according to a prescribed regimen. As another example, the trigger event may be caused if a timer has expired indicating the patient is not adhering to a prescribed regimen (e.g., taking too few or too many pills). In the illustrated example, the smartphone app may relay such an alert message to the smart collar (e.g., which may provide an audible or visual alert to a patient). In some cases, providers (e.g., doctors) may actually be able to adapt a medication regimen based on the adherence information (and possibly based on other information, such as bio-informatics obtained for the patient).

While the illustrated examples of FIG. 5A and 5B shows indirect communication between the smart collar 110 and the cloud (via wireless device 140), a similar sequence of messages could be exchanged directly between the cloud and smart collar (e.g., eliminating step 2 in both cases).

### An Example Smart Collar

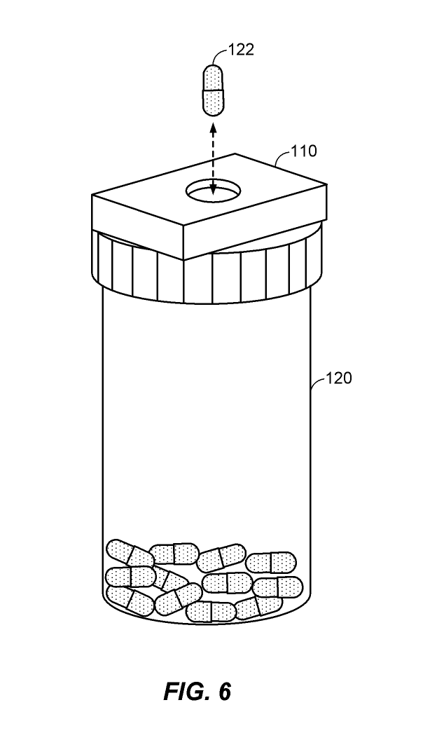

FIG. 6 illustrates an example container with a smart collar for monitoring removal and/or insertion of items from the container, in accordance with certain aspects of the present disclosure. As illustrated, the smart collar may seamless integrate with existing types of pill bottles.

In some cases, the smart collar may be automatically activated (turned on and begin monitoring/reporting) when attached to bottle. This activation may take place, for example, when configured with regimen and/or medicine information. In some cases, the collar may be designed to make it very difficult to remove once it is attached (e.g., via a mechanical device). This may allow for “lifetime tracking” of the container and/or its contents. In some cases, other sensor information (besides removal for adherence) may be monitored (e.g., over the lifetime). Examples of such sensor information may include humidity, temperature, impact, or even location (e.g., via GPS or other means).

In some cases, a sensor may detect removal and trigger an alarm and/or sending of a message. As noted above, the collar may record and report removal of pills from container 120. In some cases, the collar may include some type of visual tamper detection (e.g., such as the “twist off caps” with break-off rings sometimes used on certain types of bottles). Various other types of container (e.g., bottle) security may also be implemented, for example, for tamper detection as well as counterfeit detection (e.g., using a secure ID).

In some embodiments, the sensor may comprise a photodetector or camera (or machine vision) device. The photodetector may be used in conjunction with timing to identify when a potential foreign object or contaminant is introduced to the container 120. In some embodiments, the camera or machine vision system may capture photographs or images of the contents of the container or of items being dispensed from or introduced to the container 120. In some embodiments, the smart collar 110 (e.g., via the processor 802) may be configured to identify from the captured images an improper item in the container or a contaminant. In some embodiments, the identification may be offloaded to an external processor (e.g., of the smartphone 130). In some embodiments, the determination or identification of a contaminant or improper item may be performed by comparing the captured image to known images. Accordingly, items of different size, shape, color, texture, etc., may be identified as being a contaminant.

This monitoring functionality may be combined with certain “user facing” communications (e.g., alerts or other type notification). Such alerts/notification may be provided by any suitable techniques, for example, via the smartphone app or via a contact person/means identified by the platform. In some cases, the smart collar may include a mechanism for alerts, such as a buzzer or speaker for audible alerts and/or an LED or display for visual alerts.

In some cases, a collar may be provisioned with information that uniquely identifies the drug (e.g., drug type, manufacturer, date, location, and an authentication ID)—this may be in conjunction with the lifetime tracking mentioned above and may also be used to verify origin and authenticity of drug. Such provisioning may also include medication use guide/information.

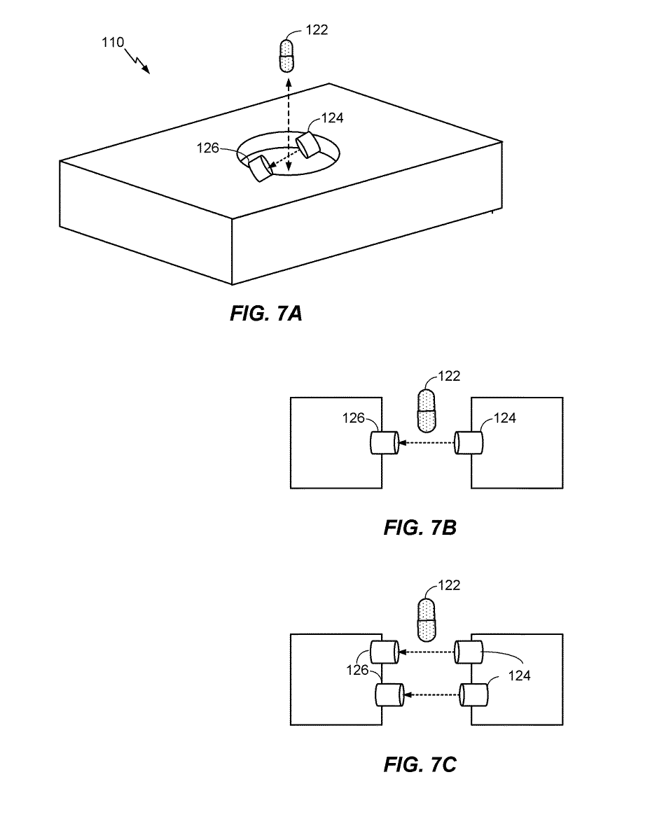

FIG. 7A-7C illustrates example smart collars with one or more sensors to detect travel of an object (such as a pill) from an opening of the smart collar, in accordance with certain aspects of the present disclosure. As noted above, for relatively low cost, a sensor arrangement may allow a smart collar to provide relatively accurate results (e.g., a pill count with “per-pill” resolution).

As illustrated in FIGS. 7A and 7B, one type of sensor arrangement may be a photo interrupter formed by an emitter 124 (e.g., LED) and a detector 126 (e.g., a phototransistor). In such a case, passage of a pill 122 (or other object) may be detected as an interruption in light (emitted from emitter 124) detected at detector 126. As illustrated in FIG. 7B, the emitter/detector pair may be located at an opening through which the object passes. In some cases, the removal (or insertion) of multiple pills may be detected by monitoring the signal (e.g., and how long the path is interrupted based on pill size).

As illustrated in FIG. 7C, in some cases, multiple photo interrupters may be offset (e.g., vertically or horizontally). The offset may help determine direction (to discern removal from insertion) of movement of the object based on which photo interrupter path is interrupted first. In some cases, multiple photo interrupters may also be offset at different angles about the opening, which may help provide results that are more accurate. More elaborate sensing schemes may also be used, albeit in some cases with an increased cost. In some embodiments, the multiple photo interrupters may comprise a single light emitter 124 and multiple detectors 126.

While the examples shown in FIGS. 7A-7C utilize a photo-interrupter, various other approaches may be used for pill counting. For example, various other types of optical sensors may be used, such as a one or more cameras or other imaging methods, placed in multiple topologies (centralized or distributed).

In some cases, rather than a photo interrupter (also known as a transmissive optical sensor), a reflective optical sensor may be used. Transmissive optical sensors detect an object when a light beam is interrupted. Reflective optical sensors measure the amount of light reflected by a passing object. Other types of mechanical or proximity sensors may also be used. In general, any suitable mechanism capable of detecting addition or removal of objects from a container (e.g., pills from a bottle) may be utilized.

In some cases, one type of sensor that may be included is an accelerometer. In such cases, the accelerometer may be used for various functions including: power management, discerning removal from insertion, and collecting information about bottle motion. In some cases, sensor fusion may be performed to improve event detection accuracy. In some embodiments, the accelerometer may provide an indication of an orientation of the smart collar 110 or any other motion. Accordingly, the accelerometer may indicate when the container 120 is tilted or rotated in a particular direction to dispense medication or when it is in an upright (or non-dispensing) position. Thus, the accelerometer may be used to discern when medication is being dispensed or when medication is being inserted. For example, when the accelerometer indicates a tilted position and the photodetector sensor sees passage of medication, the smart collar 110 (via the processor 802) may determine that medication is being dispensed. When the accelerometer indicates a non-tilted position and the photodetector sensor sees passage of medication, the smart collar 110 (via the processor 802) may determine that medication is being inserted.

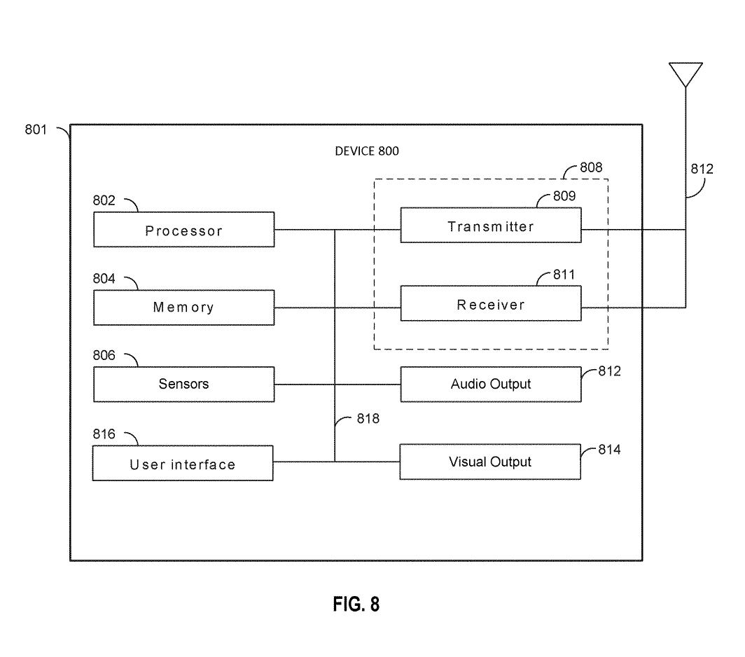

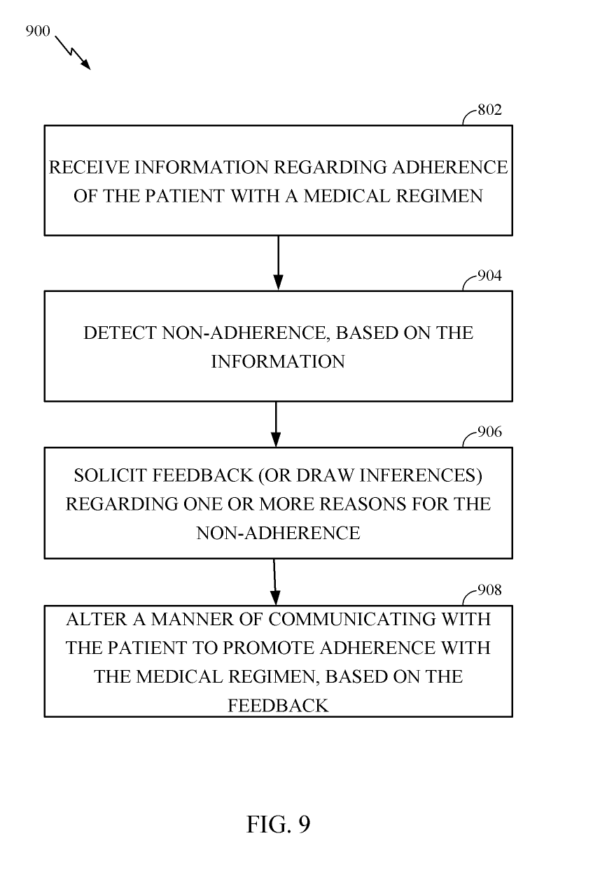

FIG. 8 illustrates an example schematic diagram of a device, in accordance with aspects of the present disclosure. FIG. 8 illustrates various components that may be utilized in a device 800 of the network 140 e.g., the smart collar 110, the smartphone 130, or the server 150 described in connection with FIG. 1) that may be employed within the system 100 of FIG. 1. The device 800 is an example of a device that can be configured to implement the various methods described herein. In some embodiments, the device 800 may be the smart collar 110 or the server 150 or the smartphone 130. With respect to the description of FIG. 8 herein, some of the item numbers may refer to the so-numbered aspects described above in connection with FIG. 1.

As illustrated, the smart collar may include a processor 802, which controls operation of the device. The processor 802 may also be referred to as a central processing unit (CPU) or hardware processor. Memory 804, which may include both read-only memory (ROM) and random access memory (RAM), provides instructions and data to the processor 802. A portion of the memory 804 may also include non-volatile random access memory (NVRAM). The processor 802 typically performs logical and arithmetic operations based on program instructions stored within the memory 804. The instructions in the memory 804 may be executable to implement the methods described herein. Furthermore, the device 800 may utilize the memory 804 to store information about other devices on the network to enable the use of certain methods described below, e.g., storing identifiers for particular smartphones 130 or servers 150 and/or characteristics for the smartphone 130 or servers 150 on the network 140. The device 800 may then utilize the processor 802 in connection with the memory 804 to analyze the dispensing and inserting events, medication regimen data, and time to determine and/or identify adherence or non-adherence conditions of the medication regimen. In some implementations, the processor 802 may include a clock (or the device 800 may include a standalone clock, not shown in this figure). The clock may be used to allow the device 800 to track a time (e.g., a time at which an object is dispensed from or inserted into the container 120).

The smart collar 110 may also include memory 804, for example, In some embodiments, the memory 804 may store instructions executable by processor 802, to store configuration information, adherence information (e.g., pill count), or other type of information. As noted above, in some cases, memory 804 may include information regarding medication (dosage, precautions, and the like) as an alternative (or in addition) to information typically provided in print form.

The processor 802 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. The processor 802 may further comprise a packet generator to generate packets for controlling operation and data communication.

The device 800 may include a transmitter (transmitter circuit) 809 and a receiver (receiver circuit) 811 to allow transmission and reception of data between the device 800 and a remote location and/or device. The transmitter 809 and the receiver 811 may be combined into a transceiver 808. An antenna 812 (or multiple antennas) may be electrically coupled to the transceiver 808. The device 800 may also include (not shown) multiple transmitters, multiple receivers, multiple transceivers, and/or multiple antennas, which may be utilized during multiple-input multiple-output (MIMO) communications, for example. In some embodiments, each of the multiple antennas may be dedicated for the transmission and/or reception of LTE-U, LTE-D, MuLTEfire, and/or WLAN communications. The wireless device may be covered by a housing unit 801.

In some embodiments, the device 800 may also comprises a modem or other communication means (not shown in this figure). For example, the additional communication means may enable the device 800 to send, receive, and process communications, for example via a particular communication medium or protocol. As noted above, the communication means or the transceiver 808 may include any type of wireless interface suitable to allow the device 800 to communicate directly or indirectly, via one or more antennas with the network 140 or any other network.

The device 800 may also include sensors 806 that may be used in an effort to detect and quantify various conditions that the device experiences. For example, in the smart collar 110, the sensors 806 may be used to detect dispensing or inserting of medication into and from the container 120. In some embodiments, the processor 802 may receive input from the sensors 806 (e.g., photo interrupters described above) to detect removal/insertion of pills. In addition, the sensors 806 may include sensors for monitoring various other parameters (e.g., temperature, humidity, location, and the like).

The device 800 may further comprise a user interface 816 in some aspects. The user interface 816 may comprise a keypad, a microphone, a speaker, and/or a display. The user interface 816 may include any element or component that conveys information to a user of the device 800 and/or receives input from the user.

Various components of the device 800 may be coupled together by a bus system 818. The bus system 818 may include a data bus, for example, as well as a power bus, a control signal bus, and a status signal bus in addition to the data bus. Those of skill in the art will appreciate various components of the device 800 may be coupled together or accept or provide inputs to each other using some other mechanism.

Although a number of separate components are illustrated in FIG. 8, those of skill in the art will recognize that one or more of these components may be implemented not only with respect to the functionality described above, but also to implement the functionality described above with respect to other components. For example, the processor 802 may be used to implement not only the functionality described above with respect to the processor 802, but also to implement the functionality described above with respect to the sensor 806 and/or the user interface 816. Each of the components illustrated in FIG. 8 may be implemented using a plurality of separate elements.

As noted above, the device 800 may comprise the smart collar 110 or the smartphone 130, and may be used to transmit and/or receive communications over licensed or unlicensed spectrums and/or exchange communication with each other and/or other devices on the network 140.

The processor 802 may be configured to carry out operations described above. For example, when the device 800 implements the smart collar 110, the processor 802 may help activate the smart collar 110 upon detecting its deployment (e.g., installation on a bottle) to begin monitoring of patient adherence.

As noted above, the smart collar 110 may also include mechanisms to provide audible and/or visual alerts. For example, the smart collar 110 may include a buzzer (or speaker) 812 to provide audible alerts and/or an LED (or display) 814 to provide visual alerts.

In some cases, processor 802 may take measures to conserve power, for example, so the smart collar can operate off a single battery for an extended period (e.g., years). To that end, the processor 802 may implement any combination of one or more power optimization techniques to conserve power while monitoring sensors and/or transmitting messages.

In some embodiments, the smart collar 110 may be configured to operate in an isolated manner (e.g., without communications to the cloud network described herein or with minimal such communications). For example, in some embodiments, the smart collar 110 may be configured to perform active adherence, or closed loop monitoring, of the patient adhering to the medication regimen. The active adherence or closed loop monitoring may include determining, without communicating with the smartphone 130 or the server 150, that the patient is adhering to the medication regimen.

When the smart collar 110 performs the active adherence or closed loop monitoring itself, the smart collar 110 may be configured to monitor dispensing and inserting events and compare those events with the medication regimen of the patient. For example, the smart collar 110 may store the events in its memory (e.g., memory 804) and compare the times of the events with the expected times as indicated in the medication regimen. Accordingly, the smart collar 110 may actively monitor the patient's adherence to the medication regimen in a closed loop without requiring intervention or communication with any external devices. For example, the medication regimen may be stored in the memory of the smart collar 110 with the details of the medication contained within the container 120. Accordingly, the smart collar 110 may include all information it needs to perform the adherence monitoring.

In some embodiments, the active adherence may involve monitoring the dispensing of medication from the container 120 (e.g., number of pills 122 and time at which they are dispensed) via the smart collar 110 (e.g., via the processor 802). The processor 802 may further correlate the dispensing (or inserting) information with the patient's medication regimen. Correlating the dispensing information may comprise comparing the dispensing information (e.g., time, quantity of medication dispensed, etc.) with the medication regimen to see if they match or if there are any discrepancies. In some embodiments, the smart collar 110 may generate alerts to the patient to remind of the need to dispense the medication or to indicate that a dispensing period was missed. In some embodiments, the smart collar 110 may generate alerts to the patient to indicate that too much medication was dispensed and that some of the dispensed medication should be reinserted into the container 120 via the smart collar 110.

The smart collar 110 may customize alerts based on a determination that one or more dispensing events (e.g., scheduled medication use times) were missed. In some embodiments, the smart collar 110 may include varying levels of alerts and may progress to different levels based on a severity of the missed dispensing event(s). The varying levels of alerts may progressively increase in an amount of alert or in the level of attention the alert garners. For example, a low severity level alert may simply include a text message or warning. A higher severity level alert may include audible or visual alerts. Even higher severity level alerts may include calls to people associated with the patient.

Thus, if the patient misses a single dispensing event, then the smart collar 110 may determine to generate a text reminder. However, if the patient misses a consecutive, subsequent dispensing event, the smart collar 110 may advance to a different level of alert (e.g., an audible alert or visual (e.g., colored lights) alert). If many days are of events are missed, the smart collar 110 may advance to communicating with people associated with the patient, healthcare providers, or emergency response personnel.

In some embodiments, the smart collar 110 may be configured to encrypt and record each dispensing event (and any insertion events). In such embodiments, the patient's smartphone 130 may be configured to communicate the encrypted and/or recorded information to a device on the cloud (e.g., the server 150 that tracks the patient's adherence to the medication regimen). In some embodiments, by encrypting the dispensing and insertion events at the smart collar 110, confidentiality of the patient's healthcare information may be maximized or improved over systems that encrypt the information at the smartphone 130 or similar device. In some embodiments, the smart collar 110 may be configured to record a specified number of events in a local memory (e.g., the memory 804). This ability to record the events in local memory 804 may allow the smart collar 110 to be synchronized on a less frequent basis than smart collars 110 without local memory 804. Such less frequent synchronization may promote power savings for the smart collar 110 and reduced transmission of healthcare information. In some embodiments, the smart collar 110 may be configured to communicate with the smartphone 130 and the devices in the cloud with minimum latency. The minimum latency may provide for more prompt monitoring when a patient took or missed their pills 122, how many pills 122 were dispensed or missed, and compare the monitored events to medication regimen (e.g., schedule) they have been given by their healthcare provider. Accordingly, the cloud device monitoring the events may act on discrepancies or non-adherence events.

In some embodiment, when the processor 802 is encrypting the information for communication to the smartphone 130 or the server 150, the processor 802 may first select an encryption key from a library of encryption keys. In some embodiments, each device with which the smart collar 110 communicates may have its own encryption key. In some embodiments, the encryption key may be rotating to minimize the likelihood of the encryption key being guessed by an adverse party. In some embodiments, different devices of the network 140 may utilize different encryption keys. For example, a pharmacy communicating over the network 140 may use a first encryption key while a healthcare provider communicating over the network 140 may use a second encryption key. Similarly, a third encryption key may be used by the patient's family or home network. Accordingly, the processor 802 may select the encryption key to user from the library of encryption keys based on the destination of information being communicated. In some embodiments, the processor 802 may include the encryption key in the encrypted information for ease decryption.

Similarly, in some embodiments, the processor 802 may be configured to decrypt information that is received via the network 140. For example, the smart collar 110 may receive an encrypted communication regarding the medication in the container 120. Accordingly, the smart collar 110 may identify a proper decryption key to use (e.g., from the library of encryption keys) to properly decrypt the received communication.

In some embodiments, event reporting (e.g., the dispensing or inserting of medication as detected by the smart collar 110) may be performed in a timely but power efficient manner. For example, the smart collar 110 may determine when it is connected to one or more cloud devices (e.g., server 150) and coordinate reporting of events to the server 150 based on the connectivity status of the smart collar 110. For example, when the smart collar 110 determines that it is not connected to one or more cloud devices (e.g., server 150), the smart collar 110 may hold reporting of events in order to reduce the transmission of data during periods when the smart collar 110 is not connected to the server 150. In some embodiments, the smart collar 110 may be configured to implement a back-off procedure or other communication scheduling procedure. In some embodiments, when the smart collar 110 detects an event, the smart collar 110 implements a power efficient communication algorithm to connect to the server 150. For example, the algorithm may include the back-off procedure and may include storing of multiple event information for communication to the server 150 once the communication to the server 150 is re-established.

### Example Tailored Communications With a Patient

Aspects of the present disclosure also provide for tailored communications with a patient.

In general, such tailoring of communications may involve a change to a combination of various factors effecting communications. Examples of such factors include content (e.g., what is communicated), method (e.g., how such content is communicated), when (e.g., time and/or frequency of the communications), and whom (e.g., the recipient of such communications).

Certain examples described below involve tailoring of communications based on explicit feedback (e.g., from patient or extended circle). However, such examples are intended to facilitate understanding and are not limiting. Rather, many different processes/events/information may cause tailoring, including but not limited to compliance, location, and history of behavior (e.g., if user always forgets to take his medication when he goes to work, so a reminder as they head to work may be effective). Other examples that may cause tailoring include analysis of stress (either measured by a biometric sensor, or looking at meeting schedule, or email load, or traffic conditions, etc.) to tailor how and when to communicate, travel plans (e.g., knowing when/where communications are likely to help). Other examples include external variables (news, weather, traffic, Family, holidays, etc.), calendar information (e.g., if in meeting, do not disturb).

A long term goal of tailored communications may be to provide a system that is a constant source of monitoring and reminding (e.g., a “virtual mother”) that will learn and understand how to best interact with the patient to improve/maintain compliance (e.g., even if this means no communications in some cases).

As described above, tailoring may involve changing any combination of content (what), method (how), and frequency (how often) of communications. As such, tailoring may be as simple as turning on a light on the collar, to changing wording in an alert, to delivering an audio message (e.g., via an Echo or other type of device), to interrupting a TV show (e.g., via an overlay or replacement), and/or reaching out to patient, family, physician, or some other person associated with the patient.

Again, the tailoring may be based on explicit feedback (e.g., asking the patient), implicit feedback (everything else), or a combination of explicit and implicit feedback. In general, the platform described herein may provide a user (patient) control (a voice) in selecting how/when to be effected (“touched”) by tailored communications. The control may be regarding how (e.g., via phone, TV, Echo), where (e.g., home, work, gym, family visit, car, etc.), or what to receive as a communication (e.g., a personal note, favorite role model, or some “off the shelf” type of communication).

Tailoring may also be based on some type of implicit/inferred reasons for non-adherence. As an example, such implicit/inferred feedback may involve reasons for the non-adherence is solicited or inferred/implicit.

For example, a mode of communicating with the patient to encourage adherence to a medication regimen may be adjusted based on feedback or inferences regarding why the patient is not adhering to the regimen. In this manner, non-effective forms of communicating with the patient may be abandoned or altered in favor of alternative forms that may lead to better adherence.

FIG. 9 illustrates example operations 900 that may be performed for tailoring communications to a patient, in accordance with certain aspects of the present disclosure. The operations 900 may be performed, for example, at server 150 (or some other component in the cloud network). In some embodiments, the operations 900 may be performed by one or more of the components of the smart collar 110 (as shown in FIG. 8A) or of the device 850, which may comprise a smart phone (as shown in FIG. 8B).

The operations 900 begin, at block 902, by receiving information regarding adherence of the patient with a medication regimen. As described above, the information may be received from a smart collar and possibly relayed to another device on the via a smartphone application. In some embodiments, the information regarding adherence may include details of the medication regimen as received from or generated by healthcare provided. In some embodiments, the information regarding adherence may include details regarding the dispensing, use, distributing, or distribution of the pills from the container via the smart collar 110. In some embodiments, the details of the medication regimen may be accessed by the device performing the operations 900. For example, if the operations 900 are performed by a device of the healthcare provider, then the details of the medication regimen may be directly available to the device.

At block 904, non-adherence with the medication regimen is detected or determined based on the received information. For example, the non-adherence may be determined based on identifying that the received information regarding the dispensing of the pills and comparing that received information to the medication regimen. In some embodiments, non-adherence may include an improper quantity of the pills being disposed at the proper time or frequency. In some embodiment, the non-adherence may include the proper quantity of pills not being dispensed at the proper time or at the proper frequency.

At 906, feedback regarding one or more reasons for the non-adherence is requested from the patient or a person (or people) associated with the patient. In some embodiments, the reason for the non-adherence may be inferred by the device performing the operations 900. In some embodiments, the feedback request may include a prompt that is provided to the patient or person associated with the patient. Thus, the feedback request may prompt the patient to explain why the non-adherence occurred. When the non-adherence is inferred, the device may monitor various activities of the patient (e.g., the patient's calendar, patient's location, etc.). Accordingly, the device may determine that the non-adherence may be caused by the patient being in a meeting if the calendar shows a meeting scheduled during the scheduled medication dispensing time. Alternatively, the device may determine non-adherence reasons when the device determines that the patient is at a gym or at in a movie, etc. Accordingly, the device may infer reasons for the non-adherence or request the reason from the patient. In some embodiments, the device may select or determine whether to infer the non-adherence or request feedback. The selection may be based on whether or not additional information (e.g., the patient's calendar, location information, etc.) is available or whether the patient is adept at using the smartphone or other feedback providing device. In some embodiments, the feedback providing device may include the patient's smartphone.

In some embodiments, requesting the feedback may further comprise receiving the feedback from the patient or the person/people from whom feedback is requested. The feedback may be received from the patient's smartphone or via any other feedback providing means (e.g., I/O of the device). In some embodiments, the received feedback may indicate that the patient never received previous alerts.

At 908, a customized communication or manner of communicating with the patient to promote adherence to the medication regimen is generated or altered, based on the feedback or the inference. In some embodiments, the device may determine, based on the non-adherence being caused by the patient being at the gym, to customize communications to remind the patient before arriving at the gym or before the scheduled event. In some embodiments, when the device determines that the patient will be with another person, the device may customize communications to the other person to remind the patient. In some embodiments, the device may customize alerts to the patient (e.g., generating and/or sending reminders via the patient's smartphone, using communicating means that art integrated into the smart collar 110, or the feedback providing device.

In some embodiments, customizing the communication or the manner of communicating may comprise altering a previously established manner of communicating or communication to the patient. For example, if the previous communication or manner of communicating includes sending an alert directly to the patient, the customized communication or manner of communicating may be altered to be directed to a person or people associated with the patient.

Alternatively, or additionally, the customizing may comprise altering a type of communication or manner of communicating (e.g., changing a text or visual alert to an audible alert). In some embodiments, the customized communication or manner of communication may include reminders to the patient to assist in maintaining adherence to the medication regimen. In some embodiments, the customizing may comprise altering one or more of: how the communication is conveyed to the patient, what device conveys the communication to the patient, when the communication is conveyed to the patient, or what information is conveyed in the communication to the patient. In some embodiments, the communication or manner of communicating may comprise at least one of an audio alert, a visual alert, or a vibrational alert

In some embodiments, the customized communication may be transmitted to the patient or the person/people associated with the patient using a transmit circuit or transmitter circuit/transmitter. In some embodiments, the customized communication may comprise altering a manner in which the patient is alerted electronically via an electronic monitoring alert, at least one a time or frequency of the communication with the patient, at least one person associated with the patient that is contacted to alert the patient, or a manner in which at least one person associated with the patient is contacted to alert the patient.

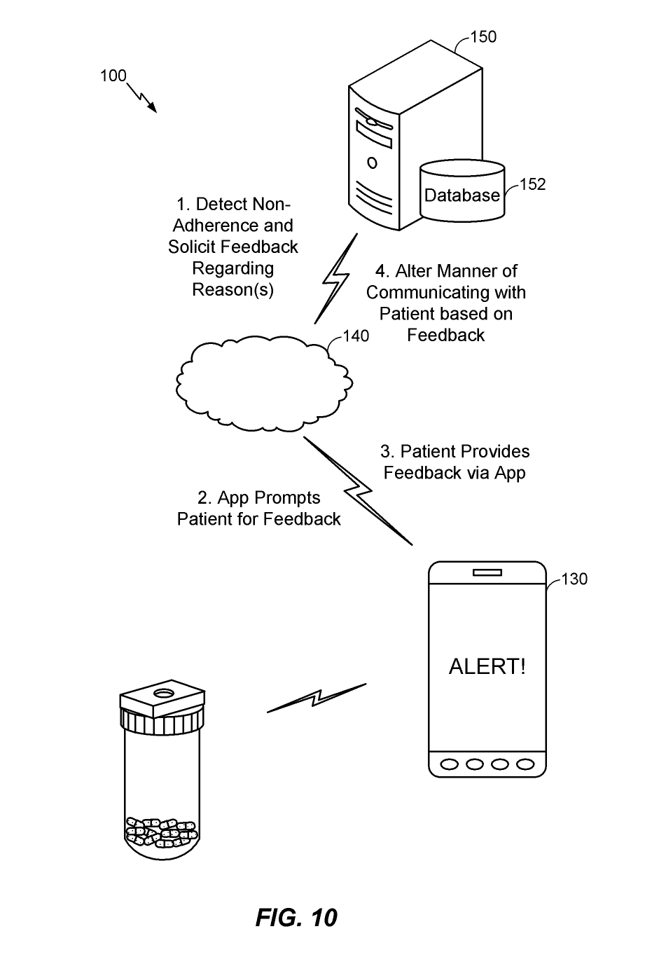

FIG. 10 illustrates an example sequence of operations for tailoring, customizing, altering communications with a patient, in accordance with certain aspects of the present disclosure. As illustrated, at step 1, the server 150 or other device may determine non-adherence (e.g., based on information received from a smart collar or possibly based on a failure to receive adherence information within a time period (which may also indicate non-adherence)). At step 2, feedback is requested or solicited, for example, by prompting the patient (or one or more people associated with the patient) for a reason for non-adherence via a smartphone app. At step 3, the smartphone app provides the feedback to the server 150 via the cloud. At step 4, the server 150 alters the manner of communicating with the patient. In some embodiments, the sequence of operations may include the various blocks of the operation 900.

In some cases, a smart-collar may provide an indication of pill count, along with time stamps of when pills are taken. In such cases, non-adherence may be detected in the number of pills removed from the container at the indicated times is not in adherence to a prescribed medication regimen. In some cases, the smart collar may have received information regarding the prescribed medication regimen and may provide that to the server.

In some cases, altering the manner of communicating with the patient may involve altering a manner in which the patient is alerted electronically via the electronic monitoring alert (e.g., altering an audio alert, visual alert, or vibrational alert).

In some cases soliciting the feedback may involve prompting multiple people associated with the patient until feedback is received. In some cases, the feedback may provide an indication that one or more adherence alerts were not received by the patient. In such cases, altering the manner of communicating with the patient may involve altering at least one a time or frequency for communicating with the patient.

In some cases, the feedback may indicate one or more locations of the patient when the one or more adherence alerts were missed and the manner of communicating with the patient may be altered based, at least in part, on the locations. For example, if the patient was at the office when the alert was missed, an updated or customized alert may be sent to an office device (e.g., computer, phone, etc.). If the patient was at the gym when the alert was missed, then the updated or altered alert may be communicated to another device of the patient (e.g., a smartwatch or media player).

In some embodiments, the smart collar may be configured as a beacon and may be used to identify a location of the container of medication. For example, when the smart collar is not performing active communications with the smartphone or cloud device, the patient may selectively activate (e.g., using the smartphone app) a beacon mode for the smart collar. In the beacon mode, the smart collar may emit, generate, and/or transmit a beacon that can be used by an external device (e.g., the smartphone) to identify a location of container comprising the smart collar. In some embodiments, the smartphone app may be used to generate a map or geolocation of the smart collar. In some embodiments, the smartphone app may be used to active one or more indicators of the smart collar (e.g., audio or visual indicators) that may help lead the patient to the container. In some embodiments, the smart collar 110 may be configured to indicate identifying information requesting that a person return a lost medication container 120 to the rightful owner. Accordingly, the smart collar 110 may provide the location of the container 120 and allow the patient to display address or meeting location information to the smart collar 110 from a remote location (e.g., via the smartphone 130).

In some cases, altering the manner of communicating with the patient may involve altering at least one person associated with the patient that is contacted to alert the patient. In some cases, altering the manner of communicating with the patient may involve altering a manner in which at least one person associated with the patient is contacted to alert the patient.

As described above, certain aspects of the present disclosure provide a cloud-based platform that may utilize a smart collar to monitor patient adherence to a medication regimen. The smart collar may provide a relatively low-cost mechanism that seamlessly integrates in existing containers (e.g., standard pill bottles of various sizes) and provides accurate monitoring of medication consumption. This information may be provided to a cloud-based monitoring system to help monitor and promote patient adherence to a regimen which may lead to improved results, potentially increasing wellness and saving both cost and lives.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members as well as combinations that may multiples of the same element.

The various operations of methods described above may be performed by any suitable means capable of performing the corresponding functions. The means may include any suitable combination of hardware, software, or both. Examples of such hardware include any suitable circuit or circuitry, such as a processor (e.g., a general purpose processor, field programmable gate array (FPGA), or application specific integrated circuit (ASIC).

Portions implemented in software may include code or instructions on a computer-readable medium. As used herein, the term software generally refers to any combination of instructions, data, or both, and may include firmware. A computer-readable storage medium may be integral to a processor of coupled to a processor such that the processor can read information from, and write information to, the storage medium. Examples of machine-readable storage media may include, for example, one or more of: any type of Random Access Memory (RAM), Read Only Memory (ROM), or any other suitable storage medium.

It is to be understood that the claims are not limited to the precise configuration and components illustrated above. Various modifications, changes and variations may be made in the arrangement, operation and details of the methods and apparatus described above without departing from the scope of the claims.

### Various Applications for Cloud-Based Platform

A cloud-based platform to monitor and promote patient adherence, as described herein, may help enable various useful applications. In addition to promoting adherence and compliance, such applications may include locating a container (e.g., “Find my drug container” and other tracking), monitoring and providing notifications regarding product expiration (e.g., based on dates and information stored locally at the smart collar) and facilitated replacement/refills, facilitating/targeted product recalls and replacement (e.g., as a provider may communicate to patients via the cloud network), helping to avoid patient prescriptions that conflict or have bad (or negative) potential interaction with other prescriptions, as well as providing possible spoilage/damage notice.

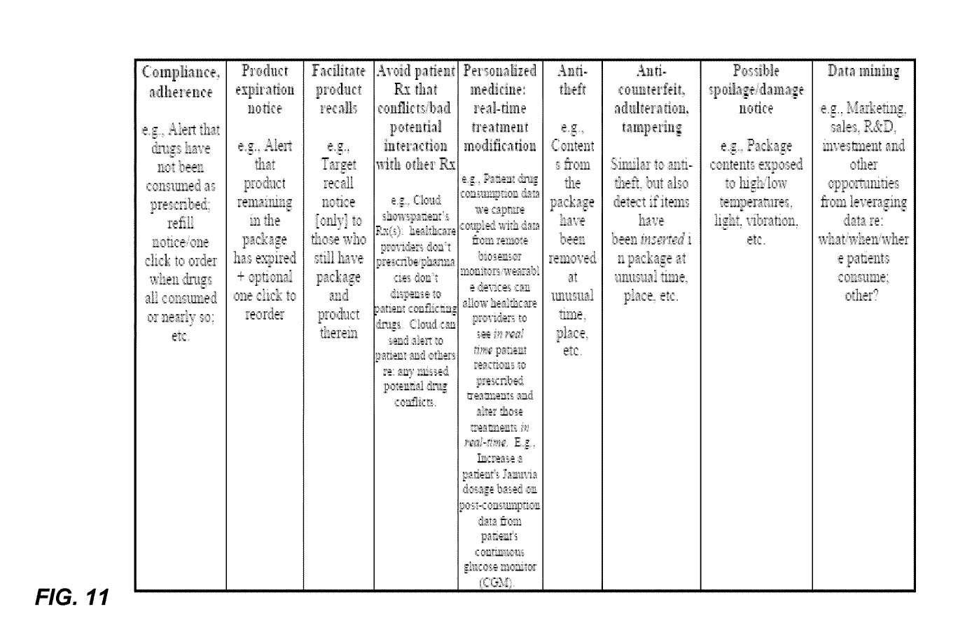

The table in FIG. 11 provides a summary of some such example applications. As described herein, for compliance/adherence, the platform may provide an alert that drugs have not been consumed as prescribed and may also provide a mechanism (e.g., via an interface on the smart collar or the smartphone app) for refill notice/one click to order when drugs all consumed or nearly so.

In some embodiments, the server 150 may provide for automatic refills of medication without needing patient or healthcare provider intervention. In some embodiments, the server 150 may utilize the monitored event information (e.g., dispensing and inserting events) to determine a quantity of medication available in the container 120 coupled to the smart collar 110. The determined quantity may be used to send a refill request to one of the healthcare provider and/or the pharmacy. In some embodiments, based on the type or details of the medication being refilled, the server 150 may determine to send the refill request or reminder with sufficient lead time to ensure that the refill is completed before or when the patient dispenses the last of the medication in the current container 120. In some embodiments, active communications between the smart collar 110, the server 150 (e.g., or any other device on the network 140) and a back end connection to a pharmacy allows the patient (or pharmacist or person associated with the patient) to specify an exact time a refill needs to be ordered. In some embodiments, coordination with the healthcare provider may be provided (e.g., when a prescription needs to be renewed or updated by the provider). In some embodiments, knowing an exact amount of medication in the container 120 as well as the medication regimen may allow a reminder to be selected based on a remaining number of pills, a remaining number of days in the regimen, or even how long it takes the pharmacy to complete a refill. In some embodiments, the selection may be performed by one of the patient, a person associated with the patient, or the healthcare provider of the patient.

Product expiration notices may also be provided via alerts that product remaining in the package has expired (and, again, may optionally provide options to reorder. For product recalls, the platform may provide targeted recall notices, for example, only targeting those (patients) who still have package and product remaining therein.

In some embodiments, the bidirectional communications between the smart collar 110 and the server 150 (or other device of the network 14) or smartphone 130 may provide for improved tracking and notification of medication expiration, medication recall, and/or general medication traceability. For example, once the medication is placed into a particular container 120 and the smart collar 110 is properly configured with details of the medication, the smart collar 110 may include information associating the medication with a particular manufacturing batch (e.g., manufacture date, line, etc.) and the patient. Accordingly, should a recall occur, the details of the medication stored in the smart collar 110 may provide for the ability to contact the patient (and even persons associated with the patient) to ensure the medication is properly discarded and/or returned and no longer consumed. Additionally, or alternatively, the details of the medication stored in the smart collar 110 may provide for monitoring of expiration dates of the medication. Accordingly, appropriate actions may be taken as necessary when medication is expired. In some embodiments, if the container 120 contains expired medication, an alarm or alert may be communicated to the patient (e.g., via the smartphone 130 or the smart collar 110). The alert or alarm may indicate that the container 110 includes expired medication that may be degraded or spoiled (e.g., via an expiration alarm or alert).

In some embodiments, the processor 802 may identify, from information stored in the memory 804 of the smart collar 110 regarding the medication, that the medication is expired. If there processor 802 is aware that there is still medication in the container 120, then the processor 802 may generate an alarm to the patient (e.g., via either the audio or visual indicators 812 and 814). This alarm may indicate to the patient that the medication is expired. In some implementations, the indication that the medication is expired may be received via the network 140 or some external device.

The cloud platform (by helping maintain information about patients and their medications) may also help providers avoid prescribing patient medications that conflict or have bad potential interaction with other medications. In such cases, the cloud platform may show (a provider) a list of a patients currently prescribed medications, so providers may avoid prescribing (or pharmacies may avoid dispensing) patient conflicting drugs. In some cases, the cloud platform may help send alerts to patients and others (e.g., regarding any missed potential drug conflicts found only after prescribing conflicting medications). In some embodiments, the prescribed medications may also be reviewed against aspects of the patient's healthcare. For example, the prescribed medications may be checked for potential allergic reactions they may cause or other adverse or negative impacts they may have on the patient.

In some cases, the platform described herein may help achieve personalized medicine, for example, allowing real-time treatment modification. In such cases, patient drug consumption data may be capture and analyzed along with data for the patient obtained from remote biosensor monitors/wearable devices which can allow healthcare providers to see in real time patient reactions to prescribed treatments and alter those treatments in real-time. As an example, the platform may allow a provider to increase a patient's dosage of a diabetes drug based on post-consumption data from patient's continuous glucose monitor (CGM) that provides information via the cloud network.

In some cases, anti-theft applications may be enabled. As an example, theft may be indicated if contents from the package have been removed at unusual time or place. Similarly, anti-counterfeit, adulteration, or tampering may be detected if items have been inserted in package at unusual time or place. In some embodiments, if the container 120 is exposed to a condition when an object was removed at an unusual o unexpected time or place or an item was inserted at an unusual time or place, the patient may be alerted. For example, the smart collar 110 or the smartphone 130 may receive an alert or signal from the cloud-based platform to display an alert regarding potential theft or tampering. In some embodiments, the smart collar 110 may include a locking mechanism that may be engaged based on a signal received from the cloud-based platform. Accordingly, the container 120 may be locked if the container 120 is stolen. In some embodiments, if the location of the container 120 is unexpected (e.g., a different state that in which the patient lives) or at a different location than the patient's smartphone 130, then cloud-platform may determine that the container 120 has been stolen.

In some cases, the cloud-based platform may help detect or prevent possible spoilage/damage, for example, if the contents are exposed to high/low temperatures, light, vibration, or the like (which may be detected by detectors shown in FIG. 8). In some embodiments, if the container 120 is exposed to adverse temperatures, light, vibration, humidity, or other conditions, an alarm or alert may be communicated to the patient (e.g., via the smartphone 130 or the smart collar 110). The alert or alarm may indicate that the container 110 has been subjected to adverse conditions and the medication may have degraded or been damaged or spoiled (e.g., via a degradation alarm or alert).

The cloud-based platform may also enable data mining. As an example, data gathered (e.g., with patient consent) regarding what/when/where patients consume medication may be used (leveraged) for marketing, sales, R&D, investment and other opportunities.

In some embodiments, a target cloud device (e.g., the server 150) may be configured to know when to expect an event report from the smart collar 110. The server 150 may know when to expect the event report based on the medication regimen. For example, when the regimen indicates that the patient should dispense a medication at 8 AM, the server 150 may determine that a dispensing event should be reported within a threshold period of time (e.g., 15 minutes). If the report is received within the threshold, then the server 150 may determine that the regimen is being adhered to and may congratulate the patient or praise the patient (or associated person, e.g., via the smartphone 130) regarding the adherence activity. Alternatively, or additionally, if the report is not received within the threshold, then the server 150 may determine that the regimen is not being adhered to and may remind the patient (or associated person, e.g., via the smartphone 130) regarding the medication regimen.

In some embodiments, if the report is not received within the threshold, the server 150 may use the lack of the report as a trigger for one or more actions. For example, the lack of the report may trigger the server 150 to test connectivity of the server 150 to a last used gateway(s). Additionally, or alternatively, the lack of the report may trigger the server 150 to test connectivity to the smart collar 110. In some embodiments, of the report is not received, the server 150 may communicate with the patient or people associated with the patient. In some embodiments, the lack of the report may trigger the server 150 to send one or more reminder(s) to the patient's app on the smartphone 130, to the smart collar 110, or to people associated with the patient. In some embodiments, the lack of a report for an extended period of time (e.g., for a time exceeding a specified number of thresholds) may indicate an emergency or similar condition for which the server 150 alerts. In some embodiments, the functions ascribed to the server 150 may be performed by the smartphone 130 or any other device on the network 140.

In some embodiments, the smart collar 110 may be in bidirectional communication with one or more cloud devices (e.g., the server 150) or the patient's smartphone 130. In some embodiments, this bidirectional communication may provide for medication reminders to be sent to the smart collar 110 or to the smartphone 130 from the server 150. For example, a reminder may be sent at least one of the smart collar 110 or the patient's smartphone 130 from the server 150 dependent upon a particular condition. For example, the condition may be indicated on the smart collar 110 or the smartphone 130 as indicated below. For example, the smart collar 110 and/or the smartphone 130 may comprise a status indicator (not shown in the figures) that illuminates green to indicate an “OK” status in which no action is required by the patient. The smart collar 110 and/or the smartphone 130 may comprise a status indicator that illuminates yellow to indicate a “Warning” status in which no action is currently required by the patient but when an action will be required within a specified period of time (e.g., medication will need to be dispensed in the next hour). The smart collar 110 and/or the smartphone 130 may comprise a status indicator that illuminates red to indicate an “Warning” status in which action is required by the patient immediately (e.g., a dispensing event was missed or is actively occurring).

In some embodiments, the smartphone 130 or a similar receiving device may receive alerts, messages, or signals from the cloud-platform. The smartphone 130 may be accessible to the patient, the healthcare provider, and/or the person associated with the patient. In some embodiments, the receiving device may be any electronic device with or on which the patient, healthcare provider, and/or person associated with the patient can receive an alert or alarm or any pertinent information about the patient's adherence or non-adherence to the medication regimen. In some embodiments, the receiving device may be any electronic device with or on which the patient, healthcare provider, and/or person associated with the patient can receive an alert or alarm or any pertinent information about the patient's medication.

In some embodiments, the smart collar 110 may be configured to not communication dispensing and inserting events for an extended duration of time. For example, if the smart collar 110 is taken to a remote location (e.g., on vacation) for an extended duration where access to the network 140 is intermittent or non-existent, the smart collar 110 may be configured to operate in a “stand alone” mode. In such a mode, one or more of the benefits described herein may not be available. For example, the customized alerts may not be available where communication between the smart collar 110 and the smartphone 130 or the server 150 is intermittent or non-existent. When operating in the stand alone mode, the smart collar 110 may be configured to locally store all necessary information for medication consumption. Accordingly, the patient may be alerted by the smart collar 110 or via the smartphone app to maintain adherence. In some embodiments, the smartphone app to smart collar 110 communications may not be dependent network 140 communications. In the stand alone mode, the smart collar 110 may be able to operate in areas where network communications (e.g., via Wi-Fi or cellular connections) is intermittent or very expensive.

As described above, certain aspects of the present disclosure provide a cloud-based platform that may utilize a smart collar to monitor patient adherence to a medication regimen. The smart collar may provide a relatively low-cost mechanism that seamlessly integrates in existing containers (e.g., standard pill bottles of various sizes) and provides accurate monitoring of medication consumption. This information may be provided to a cloud-based monitoring system to help monitor and promote patient adherence to a regimen, which may lead to improved results, potentially increasing wellness and saving both cost and lives.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members as well as combinations that may multiples of the same element.

The various operations of methods described above may be performed by any suitable means capable of performing the corresponding functions. The means may include any suitable combination of hardware, software, or both. Examples of such hardware include any suitable circuit or circuitry, such as a processor (e.g., a general-purpose processor, field programmable gate array (FPGA), or application specific integrated circuit (ASIC).

Portions implemented in software may include code or instructions on a computer-readable medium. As used herein, the term software generally refers to any combination of instructions, data, or both, and may include firmware. A computer-readable storage medium may be integral to a processor of coupled to a processor such that the processor can read information from, and write information to, the storage medium. Examples of machine-readable storage media may include, for example, one or more of: any type of Random Access Memory (RAM), Read Only Memory (ROM), or any other suitable storage medium.

It is to be understood that the claims are not limited to the precise configuration and components illustrated above. Various modifications, changes and variations may be made in the arrangement, operation and details of the methods and apparatus described above without departing from the scope of the claims.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and method steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose hardware processor, a Digital Signal Processor (DSP), an Application Specified Integrated Circuit (ASIC), a Field Programmable Gate Array (FPGA) or other programmable logic device, discrete gate or transistor logic, discrete hardware components, or any combination thereof designed to perform the functions described herein. A general-purpose hardware processor may be a microprocessor, but in the alternative, the hardware processor may be any conventional processor, controller, microcontroller, or state machine. A hardware processor may also be implemented as a combination of computing devices, e.g., a combination of a DSP and a microprocessor, a plurality of microprocessors, one or more microprocessors in conjunction with a DSP core, or any other such configuration.

The steps of a method and functions described in connection with the implementations disclosed herein may be embodied directly in hardware, in a software module executed by a hardware processor, or in a combination of the two. If implemented in software, the functions may be stored on or transmitted as one or more instructions or code on a tangible, non-transitory computer readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the hardware processor such that the hardware processor can read information from, and write information to, the storage medium. In the alternative, the storage medium may be integral to the hardware processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The hardware processor and the storage medium may reside in an ASIC.

For purposes of summarizing the disclosure, certain aspects, advantages and novel features have been described herein. It is to be understood that not necessarily all such advantages may be achieved in accordance with any particular implementation. Thus, the invention may be embodied or carried out in a manner that achieves or optimizes one advantage or group of advantages as taught herein without necessarily achieving other advantages as may be taught or suggested herein.

Various modifications of the above-described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. An apparatus for providing medication monitoring for a patient, the apparatus comprising:
a receiver circuit configured to receive a wired or wireless signal indicating information regarding dispensing of a medication from a container;
a memory circuit configured to store and provide access to at least one of the information regarding dispensing of the medication, information regarding a medication regimen of the patient, information regarding the medication, and an indication of adherence or non-adherence of the patient to the medication regimen;
a processor circuit configured to generate one or more alerts to the patient regarding at least one of: the medication, the medication regimen, and an adherence or non-adherence of the patient to the medication regimen; and
a transmit circuit configured to transmit the one or more alerts to a receiver device accessible by at least one of the patient, a healthcare provider, or a person associated with the patient.

2. The apparatus of claim 1, wherein the processor circuit is further configured to:
determine when a quantity of the medication within the container is below a threshold amount; and
generate a request to refill the medication from a pharmacy when the quantity is below the threshold.

3. The apparatus of claim 1, wherein the receiver circuit is further configured to receive information regarding the patient's healthcare and wherein the processor circuit is further configured to:
identify conflicts or negative interactions between the medication and other medications prescribed to the patient; and
identify adverse interactions between the medication and other aspects of the patient's healthcare.

4. The apparatus of claim 3, wherein the information regarding the patient's healthcare includes allergy information and wherein identifying adverse interactions between the medication and other aspects of the patient's healthcare comprises identifying an allergy potential in the medication.

5. The apparatus of claim 1, wherein generating the one or more alerts to the patient comprises generating an adherence alert indicating that the patient is not adhering to the medication regimen or that the patient is adhering to the medication regimen.

6. The apparatus of claim 5, wherein when the adherence alert is generated to indicate that the patient is not adhering to the medication regimen, the processor circuit is further configured to schedule one or more reminders or notifications to the patient to help the patient adhere to the medication regimen.

7. The apparatus of claim 1, wherein generating the one or more alerts to the patient comprises generating a medication alert to the patient, wherein the medication alert indicates that that the medication contained within the container is nearing expiration, has expired, or has been recalled.

8. The apparatus of claim 1, wherein generating the one or more alerts to the patient comprises generating a degradation alert to the patient, wherein the degradation alert indicates that the container has been exposed to improper temperatures that may cause the medications to degrade.

9. The apparatus of claim 1, wherein the receive circuit is further configured to receive a location of the container and wherein the transmit circuit is configured to transmit the location to the patient.

10. A method of providing medication monitoring for a patient, the method comprising:
receiving a wired or wireless signal indicating information regarding dispensing of a medication from a container;
storing and providing access to at least one of the information regarding dispensing of the medication, information regarding a medication regimen of the patient, information regarding the medication, and an indication of adherence or non-adherence of the patient to the medication regimen;
generating one or more alerts to the patient regarding at least one of: the medication, the medication regimen, and an adherence or non-adherence of the patient to the medication regimen; and
transmitting the one or more alerts to a receiver device accessible by at least one of the patient, a healthcare provider, or a person associated with the patient.

11. The method of claim 10, further comprising:
determining when a quantity of the medication within the container is below a threshold amount; and
generating a request to refill the medication from a pharmacy when the quantity is below the threshold.

12. The method of claim 10, further comprising:
receiving information regarding the patient's healthcare;
identifying conflicts or negative interactions between the medication and other medications prescribed to the patient; and
identifying adverse interactions between the medication and other aspects of the patient's healthcare.

13. The method of claim 12, wherein the information regarding the patient's healthcare includes allergy information and wherein identifying adverse interactions between the medication and other aspects of the patient's healthcare comprises identifying an allergy potential in the medication.

14. The method of claim 10, wherein generating the one or more alerts to the patient comprises generating an adherence alert indicating that the patient is not adhering to the medication regimen or that the patient is adhering to the medication regimen.

15. The method of claim 14, wherein when the adherence alert is generated to indicate that the patient is not adhering to the medication regimen, further comprising scheduling one or more reminders or notifications to the patient to help the patient adhere to the medication regimen.

16. The method of claim 10, wherein generating the one or more alerts to the patient comprises generating a medication alert to the patient, wherein the medication alert indicates that that the medication contained within the container is nearing expiration, has expired, or has been recalled.

17. The method of claim 10, wherein generating the one or more alerts to the patient comprises generating a degradation alert to the patient, wherein the degradation alert indicates that the container has been exposed to improper temperatures that may cause the medications to degrade.

18. The method of claim 10, further comprising receiving a location of the container and transmitting the location to the patient.

19. An apparatus for providing medication monitoring for a patient, the apparatus comprising:
means for receiving a wired or wireless signal indicating information regarding dispensing of a medication from a container;
means for storing and providing access to at least one of the information regarding dispensing of the medication, information regarding a medication regimen of the patient, information regarding the medication, and an indication of adherence or non-adherence of the patient to the medication regimen;
means for generating one or more alerts to the patient regarding at least one of: the medication, the medication regimen, and an adherence or non-adherence of the patient to the medication regimen; and
means for transmitting the one or more alerts to a receiver device accessible by at least one of the patient, a healthcare provider, or a person associated with the patient.

20. The apparatus of claim 19, wherein:
the means for receiving comprises a receiver circuit,
the means for storing and providing access comprises a memory circuit,
the means for generating comprises a processor circuit, and
the means for transmitting comprises a transmit circuit.
